(19) United States
(12) Patent Application Publication
(10) Pub. No.: US 2012/0103032 A1
(43) Pub. Date: May 3, 2012

(54) SECURITY COVER FOR CARGO CONTAINERS

(76) Inventor: VERNE E. THOMSEN, Ames, NE (US)

(21) Appl. No.: 13/347,286

(22) Filed: Jan. 10, 2012

Related U.S. Application Data
(62) Division of application No. 12/260,328, filed on Oct. 29, 2008.
(60) Provisional application No. 61/003,705, filed on Nov. 19, 2007.

(51) Int. Cl. E05B 65/48

(52) U.S. Cl. 70/14

(57) ABSTRACT

A security device for a shipping container of the type having doors with a vertically disposed rotatable keeper bar which is rotatable about a vertical axis and an elongated operating handle having one end pivotally secured, about a horizontal axis, to the keeper bar with the operating handle being movable between a locked position and an unlocked position with the operating handle being secured in said locked position by a hasp having a pair of legs with normally aligned holes for securing the keeper bar, the security device being adapted and arranged for securely locking said container when the keeper box is in its locked position. The security cover includes a first cover plate structure which covers the hasp and a second cover plate structure which covers the pivotal connection of the operating handle with the keeper bar. The security cover is of one-piece integral construction.

### CROSS-REFERENCE TO RELATED APPLICATION

This application is a divisional application of application Ser. No. 12/260,328, filed on Oct. 29, 2008, entitled SECURITY COVER FOR CARGO CONTAINERS, which is based on and claims priority to U.S. Provisional Application Ser. No. 61/003,705, filed on Nov. 19, 2007, which is hereby incorporated herein by reference.

### BACKGROUND OF THE INVENTION

1. Field of the Invention

The present invention is directed to locking and securement devices for trailers, trucks and train cars and, more particularly, to an improved security cover system for cargo container latches which protects not only the hasp of a shipping container latch, but also covers and protects the connection of the door handle to the door locking bar to prevent an intruder from popping the handle off of the door locking bar and then opening the door locking bar to access the contents of the shipping container.

2. Description of the Related Art

Many different types of transportation devices are used to ship goods, including shipping containers, tractor-trailers, railroad freight cars, and numerous other transportation devices. However, regardless of the type of transportation device used for the shipping of goods, securing such transport devices against unauthorized access has proven to be a most difficult task. Various devices have been proposed in the prior art, including padlock-type security devices such as those disclosed in U.S. Pat. Nos. 4,898,008 and 5,477,710 and door seal lock devices such as those disclosed in U.S. Pat. Nos. 6,009,731 and 6,036,240. However, each of these prior art devices include inherent deficiencies which permit breaches of their security and which therefore render them less than ideally suited for the task of securing a transportation device against unauthorized entry. There is therefore a need for an improved securement system for transportation devices such as cargo containers and tractor-trailers which addresses and solves these deficiencies.

One additional device disclosed in the prior art is shown in U.S. Pat. No. 6,846,024 (hereinafter “the '024 patent”), which discloses a security cover system for cargo container latch which provides a significant improvement over many of the devices found in the prior art, yet which does not fully solve the problems encountered when determined persons attempt to gain unauthorized entry to the cargo container. Specifically, as shown in the '024 patent, particularly FIGS. 2-5 thereof, a security cover 50 is positioned over the hasp 42 and handle 44 in such as way as to completely cover and enclose the hasp and central portion of the handle. A locking pin is then inserted therethrough to secure the hasp in closed position and the cover 50 protects the hasp from unauthorized entry. However, the cover 50 does not protect the connection of the handle 44 to the keeper bar 46, and therefore a person attempting to enter the cargo container may simply pop the rivet connecting the inner end of the door handle 44 to the door locking bar 46 and then rotate the keeper bar 46 once the handle 44 has been disconnected therefrom.

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

An important object of the invention is to address the shortcomings of the prior art discussed above. In particular the invention is useful in connection with shipping containers of the type having one or more doors, a rotatable keeper bar, an operating handle for rotating the bar, and a hasp having a pair of legs with normally aligned holes for securing the bar. In the foregoing regard, it is to be noted that the handle may generally be attached to the keeper bar at a predetermined point of attachment using a rivet arrangement or the like. The components mentioned above cooperate to lock the container when arranged in a locking condition.

In accordance with the concepts and principles of the invention, a security cover assemblage is provided for shipping containers of the type discussed above. Advantageously the cover assemblage provides an improved security cover to thwart and frustrate the activities of would be thieves by not only protecting the hasp that secures the handle in a locked position, but also protecting the handle itself as well as the point where the handle is attached to the keeper bar which secures the door in closed position.

The cover assemblage of the invention may comprise a security cover including a plurality of walls defining an interior space within the cover, which interior space includes a hasp receiving, shielding and securing zone. In further accordance with the invention, the walls of the cover may include first and second spaced apart wall segments located on opposite sides of the hasp receiving, shielding and securing zone. Such wall segments each may desirably have a seal pin receiving aperture therein, which apertures are disposed in alignment with each other and with the holes of the hasp legs when the cover assemblage is in its locking condition with the hasp in the zone.

The walls of the cover may also desirably include operating handle accommodating openings therein. Such openings ideally are located, adapted and arranged so as to allow the operating handle to extend into said space when the cover assemblage is in its locking condition. The cover assemblage also may include a seal pin adapted to extend through the aligned holes and apertures when the cover assemblage is in its locking condition.

In further accordance with the invention, the security cover assemblage may include an elongated cover plate structure extending laterally away from the security cover so as to provide a protective covering for at least the portion of the handle that extends between the security cover and the point where the handle is attached to the keeper bar when the cover assemblage is in its locking condition. In a desirable form of the invention, the cover plate structure of the security cover assemblage may include a segment providing a protective covering for the point, for example the rivet, where the handle is attached to the keeper bar.

In yet another embodiment of the invention, the cover assemblage may include a locking block disposed at one end of the seal pin. In accordance with this embodiment of the invention, the cover assemblage may further include a wall portion positioned on the cover assemblage adjacent said locking block when the cover assemblage is in its locking condition with the pin in the holes of the hasp and the apertures of the wall segments of the security cover. In accordance with this embodiment of the invention, the cover assemblage may ideally include a lock mechanism extending between the wall portion and the block to hold the wall portion and the block together. Preferably, a flange element plate may be carried by the locking block so as to extend over a gap between the locking block and the wall portion in covering relationship relative thereto. When this embodiment is used it is very difficult for a would be thief to find a weak spot in the structure which may be broken so that access to the interior of the container may be achieved by breaking the operating handle the keeper bar or the hasp.

Even more desirably, the wall portion may be part of an enclosure which extends around the locking block so as to cover the entirety of the hasp when the assembly is in its locking position. In this latter regard, the enclosure may be arranged so as to extend around at least three sides of the locking block. Ideally, the pin has a longitudinal axis and the locking block and the wall portion are each elongated in a direction along said axis. Preferably the wall portion has a longitudinal dimension which is at least as long as the longitudinal dimension of the locking block. The embodiment makes it extremely difficult for a would-be thief to gain access to the interior of the container because it covers up all of the places where a thief might potentially break the keeper bar operating handle or the hasp.

### BRIEF DESCRIPTION OF THE DRAWINGS

FIG. 1 is a perspective view of the handle, hasp and door locking bar prior to installation of the improved security cover thereon;

FIG. 2 is a detailed perspective view of the present invention fitted onto and disposed in a locking condition for protecting the hasp and door handle;

FIGS. 3 and 4 are detailed top plan views of the door handle immediately prior to and after installation of the improved security cover thereon;

FIG. 5 is an exploded perspective view of an alternative embodiment of the security cover which is designed for use with tractor-trailers and the like; and

FIG. 6 is an exploded fragmentary perspective view of yet another alternative embodiment of the security cover which is designed for use with tractor-trailers and the like.

### DETAILED DESCRIPTION OF THE PREFERRED EMBODIMENTS

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

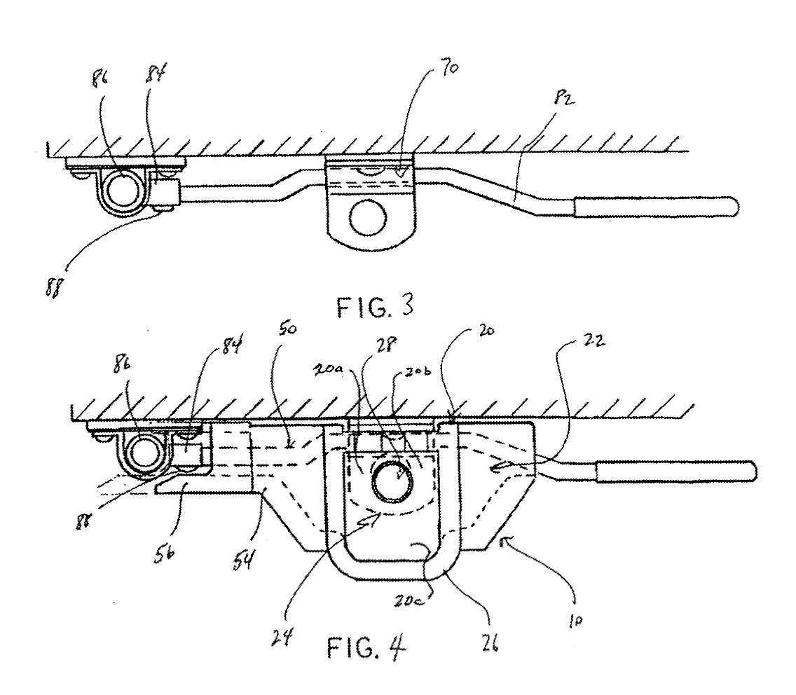

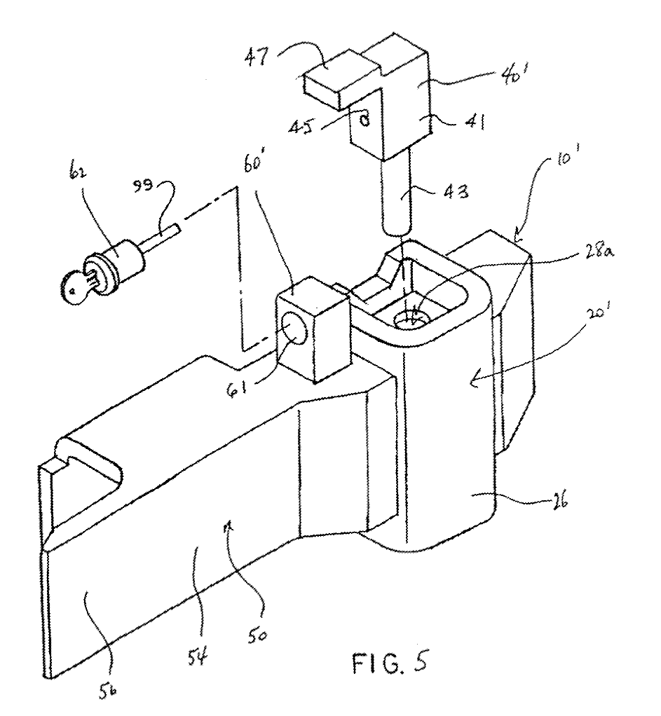

One embodiment of an improved security cover assemblage 10 which incorporates the concepts and principles of the present invention is shown best in FIGS. 1-4 as including a security cover 20 which is designed generally as described in connection with the '024 patent, specifically as including a channel 22 which in use is usually disposed to extend in a generally horizontal direction in alignment with the door handle 82 of door locking mechanism 80 and a channel 24 which in use is usually disposed to extend in a generally vertical direction in alignment with and fitted over the door hasp 70 mounted on door 90. The security cover 20 further includes an outer wall plate 26 which is contoured and designed to cover and engage the door hasp 70 and door handle 82 to prevent persons from sliding a tool such as a crowbar underneath the security cover 20 to pry it free from its position in covering relationship relative to the door hasp 70 so as to facilitate release of the door handle 82. In this regard the cover 20 defines an interior space 20a that provides a hasp receiving, shielding and securing zone 20b in channel 24. In a preferred embodiment, the security cover 20 might be constructed of a hardened steel, although other commercially available materials, such as aluminum, might be advantageously used for some applications, and cover 20 might desirably be molded into a shape such as that illustrated in FIGS. 1-4 in order to properly cover and protect the door hasp 70. The cover 20 includes a pair of walls 20c which are located in channel 24 in spaced apart relationship on opposite sides of zone 20b. Only one of the walls 20c can be seen in FIG. 4 since the other wall 20c is located directly underneath. These walls 20c each include a pin receiving hole 28. Finally, a locking pin 40 would be extended through the holes 28 in general alignment with channel 24 when the security cover is placed on the door hasp 70. At this point the hasp 70 is in zone 20b and the holes 28 are aligned with the hasp holes 76 and 78 formed in the stationary leg 72 and pivoting leg 74 of door hasp 70. Thus, pin 40 secures the security cover 20 on the door hasp 70 and therefore secures the door handle 82 within the door hasp 70, as it has been positioned between the stationary leg 72 and pivoting leg 74 of door hasp 70 prior to installation of the security cover 20 as described.

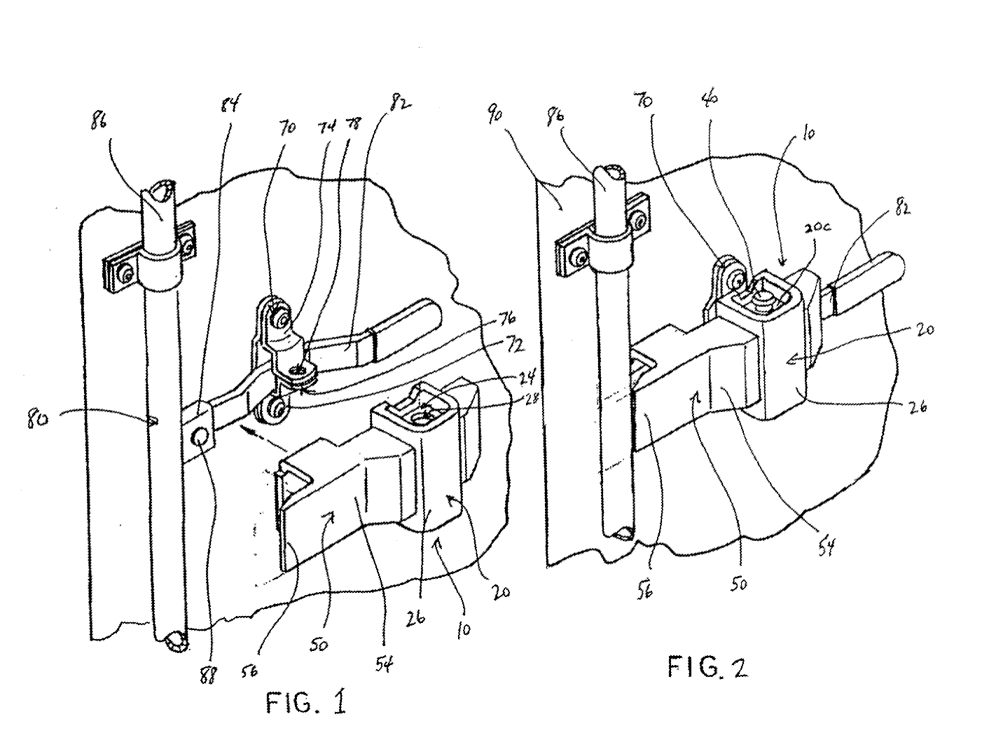

To this point, the improved security cover assemblage 10 of the present invention is generally similar to the security cover described in the '024 patent, and the entirety of the disclosure of the '024 patent is hereby expressly incorporated into the present disclosure and application by this specific reference thereto. However, the present application includes significant inventive improvements relative to the security cover of the '024 patent and these improvements will now be described with reference particularly to security cover assemblage 10 as shown in FIGS. 1-4. Specifically, mounted on security cover 20 and extending therefrom is a security sleeve and plate assembly 50 which, in the preferred embodiment, would be constructed of material similar to that used in connection with security cover 20 and would preferably include a handle-covering sleeve 54 which desirably has a generally rectangular cross-sectional shape and which is mounted on one side of the security cover 20 extending from outer wall 26 and aligned with channel 22 such that the door handle 82 extends through the channel 22, through handle-covering sleeve 54, and then connects to the door locking bar 86 via a pivotable connection 84, as shown best in FIGS. 1 and 2. In the preferred embodiment, the handle-covering sleeve 54 would have a length somewhat less than the distance between the side of security cover 20 and the pivotable connection 84 of door handle 82 to door locking bar 86 such that the handle-covering sleeve 54 abuts the pivotable connection 84 when the security cover 20 is positioned on door hasp 70, as shown in FIG. 4. It should be noted, however, that the length of handle-covering sleeve 54 may be modified or changed depending on the length of door handle 82 and the position of door hasp 70 relative to door locking bar 86, and it is not particularly critical that the handle-covering sleeve 54 be equal to the exact distance between the side of security cover 20 and the pivotable connection 84 due to the presence of the rivet cover plate 56 which will now be described.

The rivet cover plate 56 from the handle-covering sleeve 54, specifically from the inner end of the outer wall of handle-covering sleeve 54, as shown best in FIGS. 2 and 4. In the preferred embodiment, the rivet cover plate 56 would extend inwards over and above the pivotable connection 84 of door handle 82 to door locking bar 86 in order to completely cover the pivotable connection 84 when the security cover 20 and handle-covering sleeve 54 are placed on the door handle 82 and door hasp 70, as shown in FIGS. 2 and 4. In the preferred embodiment, rivet cover plate 56 would be constructed of the same materials used in connection with handle-covering sleeve 54 and security cover 20, namely a heightened tensile strength metal material such as hardened steel (although as mentioned above, these components may be constructed of aluminum for some applications), and it is further preferred that the rivet cover plate 56 be of sufficient size to completely cover the pivotable connection 84 and be of sufficient thickness that bending of the cover plate 56 relative to handle-covering sleeve 54 is virtually impossible when hand tools such as a crowbar are being used to attempt the bending thereof. It should be further noted that rivet cover plate 56 may also include top and bottom wall plates (not shown) which extend inwards towards the door 90 from the top and bottom of rivet cover plate 56 to provide additional cover and protection for the pivotable connection 84 of door handle 82 to door locking bar 86, although the inclusion of such top and bottom wall plates is not particularly critical to the present invention.

The present invention would be used in the following manner. Initially, the door handle 82 would be in an open position, i.e. removed from door hasp 70, and the handle-covering sleeve 54 would be positioned over and onto the door handle 82 until the handle-covering sleeve 54 is positioned inwards of the door hasp 70 with security cover 20 aligned with the door hasp 70. The door handle 82 would then be moved to a “locked” position to rotate the door locking bar 86 to lock the doors 90 of the container 100 in a conventional fashion. The door handle 82 would be pivoted into the door hasp 70 by being positioned on the stationary leg 72 of door hasp 70. The pivoting leg 74 of door hasp 70 would then be pivoted downwards to align the holes 76 and 78 in the stationary and pivoting legs 72 and 74 of door hasp 70, as shown in FIG. 1.

During this time, because the handle-covering sleeve 54 has larger internal dimensions than the external dimensions of the door handle 82, the security cover 20 may be shifted or moved out of the way of the door hasp 70 to permit the pivoting leg 74 thereof to be pivoted downwards as was discussed previously. Once the door hasp 70 encloses the door handle 82, the security cover 20 would be secured on the door hasp 70, with the latter in zone 20b, via locking pin 40 in a generally conventional manner. It is important to note, however, that when the security cover 20 is positioned on the door hasp 70, the handle-covering sleeve 54 of security sleeve and plate assembly 50 fits over and covers the inner portion of door handle 82, and the rivet cover plate 56 fits over and covers the pivotable connection 84 of door handle 82 to door locking bar 86. Therefore, once the security cover 20 is fastened to the door hasp 70 via the locking pin 40, the handle-covering sleeve 54 protects the door handle 82 and the rivet cover plate 56 covers and protects the pivotable connection 84. It is thus virtually impossible to “pop” the rivet 88 which connects the door handle 82 to door locking bar 86 due to the secured position of the rivet cover plate 56 thereon and the handle-covering sleeve 54 which protects the inner portion of the door handle 82. The improved security cover assemblage 10 of the present invention thus prevents unauthorized access to the interior of the container 100 via door 90 by preventing not only disengagement of the hasp 70 but also removal of the pivotable connection 84 to disconnect the door handle 82 from the door locking bar 86. The present invention thus addresses and solves a serious deficiency found in the security cover described in the '024 patent that is neither discussed nor suggested in that disclosure.

An alternative embodiment of the improved security cover assemblage 10′ of the present invention is shown in FIG. 5 as including all of the features previously described in connection with the embodiment of FIGS. 1-4, but which further includes an alternative design for the locking pin 40. Specifically, the embodiment of FIG. 5 includes a lock support block 60′ that is mounted on security cover 20′. In this embodiment, a locking block 41 is mounted on an end of locking pin 40′ as shown, and portion 43 of the pin 40′ is adapted and arranged so as to extend through the holes 28a and 28b of security cover 20′ and through hasp holes 76 and 78 of hasp 70 in the manner previously described. Lock support block 60′ has an opening 61 therein for receiving a locking device 62 which, when locked, has a pin portion 99 that engages a hole 45 in locking block 41. Significantly a plate 47 carried by locking block 41 is provided to extend over a gap located between the locking block and the wall portion in covering relationship relative thereto when the assemblage 10′ is in a locked condition.

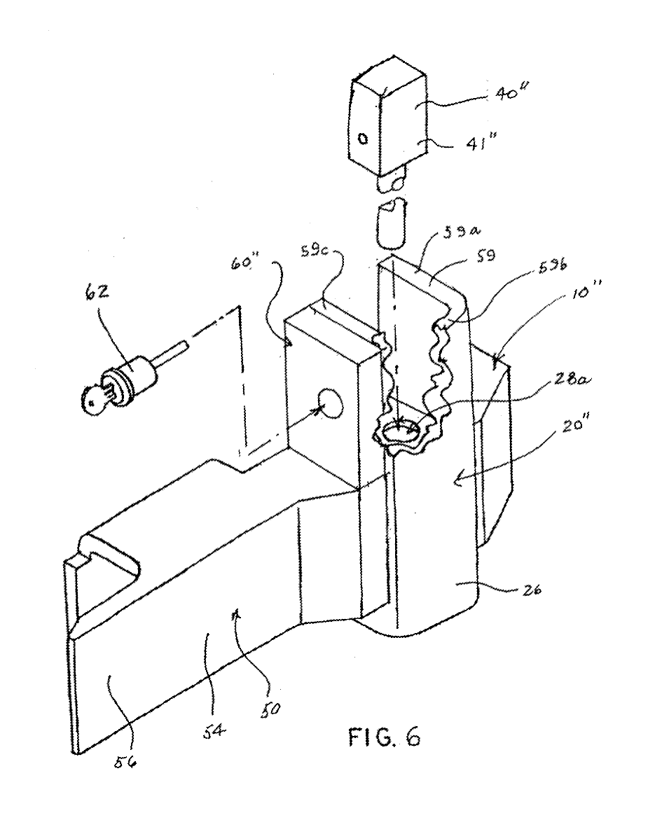

Another alternative embodiment of the improved security cover assemblage 10″ of the present invention is shown in FIG. 6 as including essentially all of the features previously described in connection with the embodiment of FIG. 5, but which further includes an alternative design for the locking pin 40″ and an enclosure 59 for the locking block 41″. As shown, the enclosure 59 desirably includes a series of walls 59a, 59b and 59c that extends around three sides of the locking block 41″. The plate 47 is not needed for this embodiment. A lock support block 60″ is mounted on security cover 20″ and block 60″ may be, but does not necessarily need to be, integral with side wall 59c of enclosure 59. Block 60″ supports locking device 62 which is used in essentially the same manner as described above in connection with FIG. 5 to lock block 41″ to block 60″ and keep the latter within enclosure 59 when the assemblage 10″ is in its operational position. In this embodiment, since the enclosure 59 desirably extends around block 41″, it necessarily provides a complete cover for the entirety of hasp 70, including even the leg 74 and its associated hardware. This would be clearly understood by one of ordinary skill in the art simply by comparing FIGS. 2 and 6.

It should be noted, however, that numerous different types of locking pins and locking devices may be used with the improved security cover assemblage 10 of the present invention, and such adaptations and modifications will likely be necessary for the present invention to be used in connection with tractor-trailers, railroad freight cars, and other transportation vehicles which include alternative devices for securing the door thereof in a locked position.

It is to be understood that numerous additions, modifications and substitutions may be made to the improved security cover assemblage 10 of the present invention which fall within the intended broad scope of the above description. For example, the size, shape and construction materials used in connection with the security cover 20, security sleeve and plate assembly 50, and the remaining elements of the present invention may be modified or changed so long as the intended functional features thereof are neither significantly degraded nor destroyed. Furthermore, although the present invention has been described for use primarily in securing transportation vehicles to prevent unauthorized access thereto, it should be noted that the improved security cover assemblage 10 of the present invention may be used in many different situations where the secure locking of a door via a locking mechanism is desired, and modifications to the present invention to adapt it for use in such situations should be understood to be a part of this disclosure. Finally, the precise size, shape and dimensions of the handle-covering sleeve 54 and rivet cover plate 56 may be modified or changed to fit on various vehicle and door locking devices, and it is expected that some degree of experimentation to accommodate such variations will be necessary, although the functionality of the handle-covering sleeve 54 and rivet cover plate 56 will remain generally the same regardless of the locking mechanism with which the present invention is connected.

There has therefore been shown and described an improved security cover assemblage 10 which accomplishes at least all of its intended purposes.

1. (canceled)

2. A security cover assemblage for a shipping container of the type having doors with inner and outer sides, a vertically disposed rotatable keeper bar at the outer side of the doors and which is rotatable about a vertical axis and an elongated operating handle having inner and outer sides with one end thereof being pivotally secured, about a horizontally disposed first pivot pin, to the keeper bar with the operating handle being movable between a locked position and an unlocked position with the operating handle being secured in said locked position by a hasp having a pair of legs with normally aligned holes for securing the keeper bar, the security device being adapted and arranged for securely locking said container doors when the keeper bar is in said locked position, the security device comprising:
a security cover including a first cover plate structure and a second cover plate structure which extends laterally from said first cover plate structure which is integrally formed with said first cover plate structure so that said first and second cover plate structures are of one-piece construction;
said first cover plate structure defining a first hasp receiving, shielding and securing zone;
said second cover plate structure defining a second operating handle receiving, shielding and securing zone;
said second operating handle receiving, shielding and securing zone including first and second portions;
said first portion of said second operating handle receiving, shielding and securing zone embracing a portion of said operating handle from said first cover plate structure to a location adjacent the keeper bar when the keeper bar is in its locked position;
said second portion of said second operating handle receiving, shielding and securing zone extending from said first portion thereof so as to be positioned outwardly of said first pivot pin to shield the same when the keeper bar is in its locked position;
said first cover plate structure including a plurality of walls defining an interior space within said first cover plate structure;
said walls of said first cover plate structure including first and second spaced-apart wall segments located on opposite sides of said first zone;
each of said wall segments of said first cover plate structure having a seal pin receiving aperture therein with said apertures being disposed in alignment with each other and with the holes in the hasp when the securing device is in said locked position with the hasp in the said first zone;
said walls of said first cover plate structure having operating handle accommodating openings therein with the openings being located, adapted and arranged to permit the operating handle to extend into said first space when the security device is in its locked position; and
a seal pin adapted to extend through the aligned holes and apertures when the security device is in its locked position;
a security cover including a plurality of walls defining an interior space within the cover, said space including a hasp receiving, shielding and securing zone,
wherein said walls include first and second spaced apart wall segments located on opposite sides of said zone, said wall segments each having a seal pin receiving aperture therein, said apertures being disposed in alignment with said holes when the assemblage is in its locking condition with the hasp in the zone,
wherein said walls include operating handle accommodating openings therein,
said openings being located, adapted and arranged to allow the operating handle to extend into said space when the assemblage is in its locking condition;
an elongated seal pin adapted to extend through the aligned holes and apertures when the assemblage is in its locking condition, said pin having a locking block disposed at one end thereof;
a wall portion positioned on the assemblage adjacent said locking block;
said wall portion being part of an enclosure which extends around at last three sides of said locking block so that said wall portion and said locking block cover the entirety of the hasp;
and a lock operatively mounted on one of said walls for engagement with said locking block to selectively lock said locking block and seal pin in a locked position.
